(19) United States
(12) Patent Application Publication
(10) Pub. No.: US 2009/0272014 A1
(43) Pub. Date: Nov. 5, 2009

(54) CARD DISPLAY AND RETENTION DEVICE

(76) Inventors: Lief C. Larson, Minneapolis, MN (US); Ann Mary Zitzmann, Minneapolis, MN (US)

Correspondence Address: INTELLECTUAL PROPERTY GROUP;FREDRIKSON & BYRON, P.A., 200 SOUTH SIXTH STREET, SUITE 4000, MINNEAPOLIS, MN, 55402, US

(21) Appl. No.: 12/262,545

(22) Filed: Oct. 31, 2008

Related U.S. Application Data
(60) Provisional application No. 60/984,927, filed on Nov. 2, 2007.

(51) Int. Cl. G09F 1/10

(52) U.S. Cl. 40/124.4

(57) ABSTRACT

A card display and retention device includes a sheet having a height and width as well as front and back surfaces. Edges spanning the height and width of the sheet frame the front surface of the sheet. A demarcation along the width of the sheet, divides the sheet into first and second portions. The first portion can be folded to form a tab for installation of the card holder in a binder having a pocket. The second portion has at least one slit for insertion of a card therein. When a card is inserted into the holder, information on a face of the card can be displayed while allowing for the card to be secured to a binder or other surface.

### RELATED APPLICATIONS

This application claims priority to U.S. Provisional Patent Application Ser. No. 60/984,927, filed Nov. 2, 2007, and titled “Card Display and Retention Device,” the contents of which are hereby incorporated by reference.

### FIELD OF THE INVENTION

The present invention relates to a display and retention device for cards, for example, business cards.

### BACKGROUND

Business cards have long been a staple of the business community as a portable, efficient means of transferring identification and communication information between parties. Commonly, a party distributing informational, marketing, or sales materials will include a copy of their business card. For example, at trade shows, vendors often distribute bundles of product related information to potential customers and include a business card for contact information.

These bundles of information are often bound in three ring binders or folders. Some binders and folders include a built-in holder for a business card. A built-in holder is often a clear plastic sleeve on an interior cover or pocket of the binder or folder. Such holders can provide for card retention while allowing for viewing of the information on an inserted card. However, these built-in holders generally do not frame or otherwise separate the card from the binder or sleeve thereby providing a presentation that is often aesthetically unfavorable. Additionally, binders and folders containing a built-in business card holder, are generally more expensive than binders and folders that do not contain such a holder.

Furthermore, other forms of affixing a card to a binder, for example stapling, can be impractical. Such methods may permanently damage the binder, or be ineffective given the binder's surface characteristics or thickness.

### SUMMARY

In one embodiment, a sheet having a plurality of slits configured for insertion of a card can be affixed to a binder or folder by one of several affixing mechanisms. In some embodiments, a portion of the sheet can be folded along a demarcation on the sheet to create a tab which can be inserted into a pocket of a binder or folder. Other embodiments include an adhesive strip or other attachment mechanism on the back of the sheet. The adhesive strip may have a non-adhesive backing which can be removed to reveal an adhesive surface for sticking the holder to a surface, such as an interior surface of a binder.

Such embodiments can provide an aesthetic presentation of card information and retention of the card with bundled materials. Further, some embodiments can be manufactured at minimal expense and used in conjunction with binders and folders that do not have built-in card holders, thereby providing a cost-effective alternative to binders and folders that have a built-in card holder.

The details of one or more embodiments of the invention are set forth in the accompanying drawings and the description below. Other features, objects, and advantages of the invention will be apparent from the description and drawings, and from the claims.

### BRIEF DESCRIPTION OF THE DRAWINGS

The following drawings are illustrative of particular embodiments of the present invention and therefore do not limit the scope of the invention. The drawings are not to scale (unless so stated) and are intended for use in conjunction with the explanations in the following detailed description. Embodiments of the present invention will hereinafter be described in conjunction with the appended drawings, wherein like numerals denote like elements.

FIG. 1A is a front elevation view of a card.

FIG. 1B is a side elevation view of the card of FIG. 1A.

FIG. 2A is a front elevation view of a card holder and a card inserted therein, according to some embodiments of the present invention.

FIG. 2B is a back elevation view of a card holder and a card inserted therein, according to some embodiments of the present invention.

FIG. 2C is a side elevation view of the card holder and card of FIG. 2B.

FIG. 3A is a front elevation view of a card holder and a card inserted therein, according to some embodiments of the present invention.

FIG. 3B is a front elevation view of a card holder and a card inserted therein, according to some embodiments of the present invention.

FIG. 3C is a front elevation view of a card holder and a card inserted therein, according to some embodiments of the present invention.

FIG. 3D is a front elevation view of a card holder and a card inserted therein, according to some embodiments of the present invention.

FIG. 3E is a front elevation view of a card holder and cards inserted therein, according to some embodiments of the present invention.

FIG. 4A is a front elevation view of an embodiment of a card holder and card installed in a binder.

FIG. 4B is a cross-sectional view along line B-B of FIG. 4A.

FIG. 5 is a side sectional view of an embodiment of a card holder and card installed on a surface.

### DETAILED DESCRIPTION OF EMBODIMENTS OF THE INVENTION

The following detailed description is exemplary in nature and is not intended to limit the scope, applicability, or configuration of the invention in any way. Rather, the following description provides practical illustrations for implementing exemplary embodiments of the present invention. Those skilled in the art will recognize that many of the examples provided have suitable alternatives that can be utilized. Additionally, the term “binder”, as used throughout the application, should be understood to include three-ring binders, folders, notebooks, booklets, and other objects for binding a grouping of papers, materials, or the like for distribution, storage, display, and similar other uses.

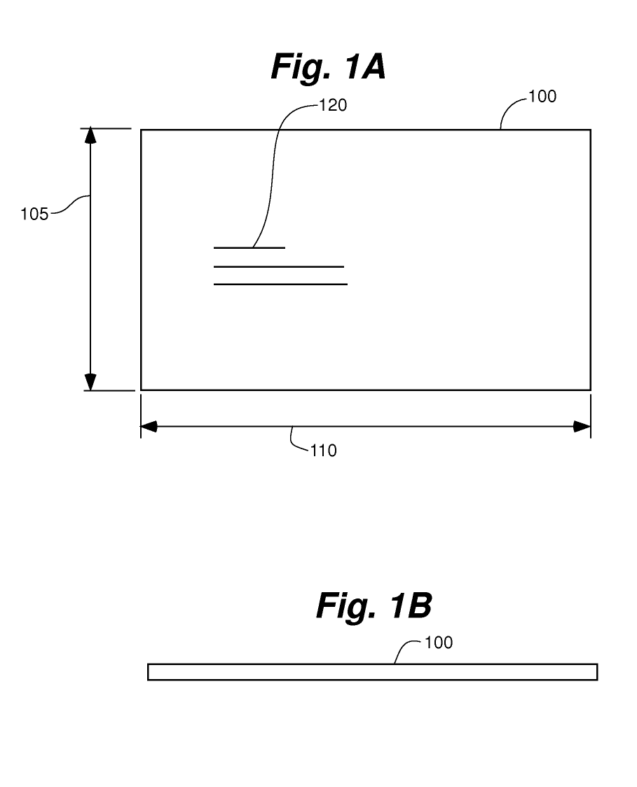

FIGS. 1A and 1B represent front and side views, respectively, of a card, such as a standard business card, index card or the like. A card 100 generally represents a flat planar sheet having a height dimension 105 and a width dimension 110. Typically, business cards are made from paper, paper board, cardboard or plastic upon which information 120 is displayed. Business cards typically have a height dimension of about 2 inches (51 mm) to about 2.165 inches (55 mm) and a width dimension from about 2.9 inches (74 mm) to about 3.6 inches (91 mm). A “standard” business card can have a height dimension of 2 inches and a width dimension of 3.5 inches. Conventional index cards comprise paper and typically are about 3 inches in height by about 5 inches in width.

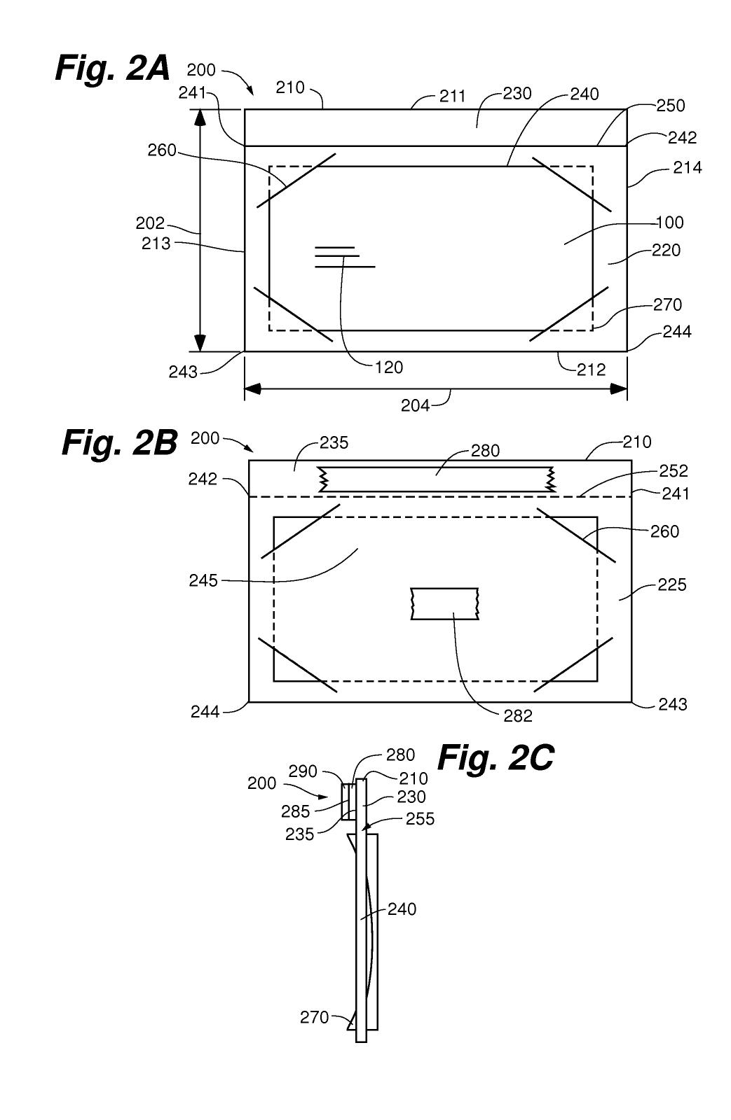

An embodiment of a card holder 200 is depicted in FIG. 2A. Here, a front elevation view of a card holder 200 having height 202 and width 204 is shown. The card holder 200 can include a sheet 210, having first, second, third and fourth edges 211, 212, 213, 214 bounding a front surface 220. In some embodiments, the sheet 210 can be divided into a first portion 230 and a second portion 240 by a demarcation 250. The demarcation 250, second edge 212, third edge 213 and fourth edge 214 meet to form corners 241, 242, 243, 244 on second portion 240. A number of slits 260 are arranged on the second portion 240 of the sheet 210 for anchoring a card 100 in place. The slits 260 can be arranged diagonally proximate corners 241, 242, 243, 244 and penetrating through the sheet 210. Inserting corners 270 of card 100, can allow for aesthetic presentation of card 100 framed by second portion 240 readily depicting information 120 while anchoring the card 100 to the holder 200.

A card holder 200 can frame a card 100 in any number of arrangements depending on the desired aesthetic effect. In some embodiments, such as that of FIG. 2A, first edge 211 and second edge 212 are generally parallel as are third edge 213 and fourth edge 214. Additionally, in this embodiment, demarcation 250 is generally parallel with the second edge 212 with the corners 241, 242, 243, 244 of second portion 240 generally forming right angles. Such an arrangement can provide a rectangular frame for an inserted card 100. It should be appreciated that other frame shapes and aesthetic effects can be obtained by altering the shape and relations of the sheet edges.

A back elevation view of an embodiment of a card holder 200 is shown in FIG. 2B. Broken line 252 indicates the location of a demarcation on the opposite front surface of sheet 210 and divides the back surface 225 into a first portion 235 and a second portion 245. Here, the back surface of the second portion 245 includes slits 260 through which protrude corners 270 of card 100. Some embodiments can include an adhesive strip 280 on the back surface of the first portion 245, and a second adhesive strip 282 on the back surface of the second portion 245.

FIG. 2C is a side elevation view of a card holder according to some embodiments. Here, corners 270 of card 100 have been inserted into sheet 210 through slits (not shown) similar to those of the embodiments of FIGS. 2A-2B. In this embodiment, groove 255 is analogous to the demarcation 250 of FIG. 2A, and separates the sheet 210 into a first portion 230 and a second portion 240. An adhesive strip 280 is attached to the back surface of the first portion 235. In some embodiments, the adhesive strip 280 may be covered with a non-adhesive backing 290 to prevent an adhesive surface 285 of the adhesive strip 280 from adhering to untargeted surfaces.

Dimensions of embodiments of the card holder depend, in part upon the dimensions of the card to be held. Examples of card dimensions are provided above. In some embodiments, the height dimension 202 of a card holder 200 can range from about 2 inches to about 5 inches allowing for a first portion 230 having a height of approximately 0.25 inches to approximately 1.5 inches and a second portion 240 having a height of approximately 1.5 inches to approximately 4.5 inches. Some embodiments have a width dimension 204 from about 4 inches to about 7 inches. In one embodiment, a card holder can include a height dimension of 3.5 inches with a 0.5 inch first portion and a 3 inch second portion, and a width dimension of 4.75 inches, for use with a “standard” 2 inch by 3.5 inch business card.

Embodiments of card holders, can be made from a variety of materials depending upon the desired aesthetic, durability, and production characteristics of the particular embodiment. In one embodiment, the card holder is made from paperboard. Other embodiments may include card holders made of poster board, plastic, polymers or other semi-rigid paper-like materials.

Some embodiments of the card holder 200 have an attachment mechanism for attaching the card holder 200 to a surface. An attachment mechanism can be a first adhesive strip 280 on the back surface of the first portion 235 and a second adhesive strip 282 on the back surface of the second portion 245, as shown in FIG. 2B. Alternative embodiments may include different numbers and placements of adhesive strips. For example, one embodiment can include a single adhesive strip 280 on the back surface of the first portion 235 (see FIG. 2C).

The demarcation 250 can include any feature distinguishing the first portion 230 from the second portion 240. For example, the demarcation can be a groove 255 as depicted in the embodiment of FIG. 2C. In other embodiments, the demarcation 250 may include a line, perforations, crease or some combination thereof. In some embodiments, the demarcation 250 can help to provide an attachment mechanism by facilitating the folding of first portion 230 relative to second portion 240 so that first portion 230 can provide a tab for insertion into a pocket or sleeve of a binder.

In the embodiment of FIGS. 2A-2B, four slits 260 are diagonally arranged at corners 241, 242, 243, 244 of the second portion 240. In some embodiments, diagonal slits 260 can measure approximately 0.25 inches to approximately 1.5 inches (e.g. 0.75 inches) each.

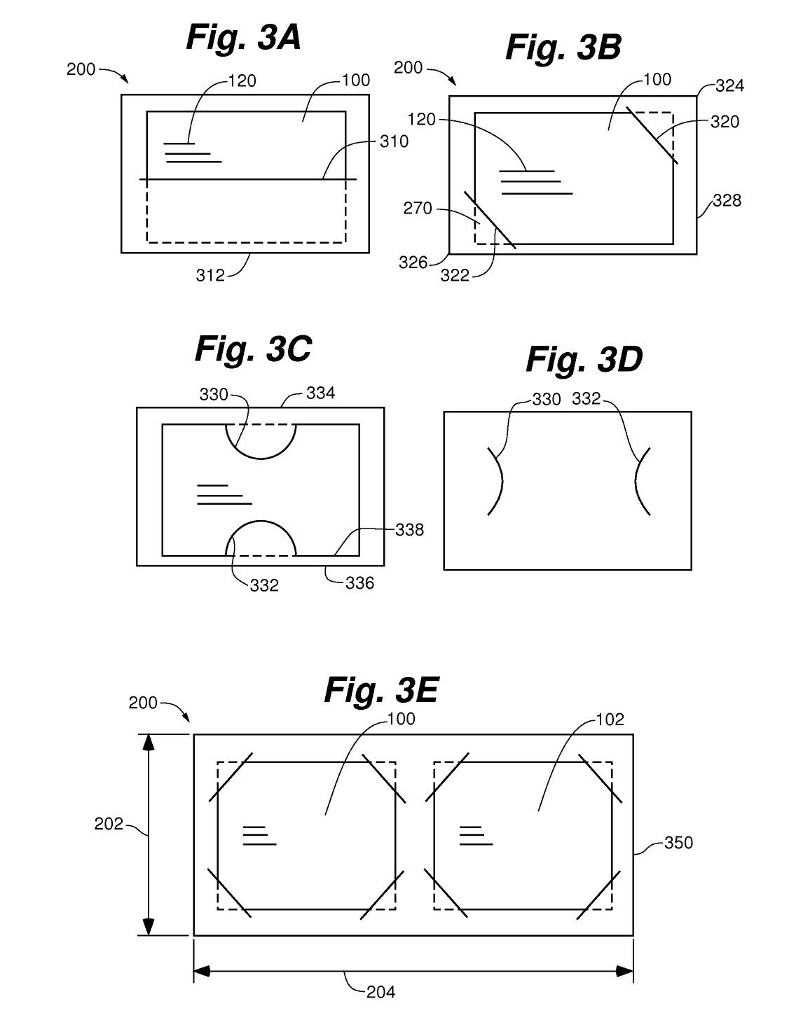

Numerous other slit arrangements, sizes, and counts are contemplated, all of which can allow for aesthetic display of card information 120 and retention of the card 100 within the card holder 200. For example, in some embodiments a card holder 200 may have a single slit 310, parallel to the second edge 312 as in the embodiment of FIG. 3A. Other embodiments, such as that shown in FIG. 3B, may have only two diagonal slits 320, 322 proximate opposite corners 324, 326 of the sheet 328. In another embodiment, such as that shown in FIG. 3C, two semi-circular slits 330, 332 can be arranged along edges 334, 336 of the sheet 338. FIG. 3D depicts yet another embodiment depicting an arrangement of slits including two semi-circular slits 330, 332 in a different orientation from that of FIG. 3C. The slit arrangements depicted in FIGS. 3A-3D are merely exemplary are not intended to be exhaustive nor limit this disclosure as numerous slit arrangements can be appreciated.

A card holder 200 can be configured to display multiple cards, such as the embodiment of FIG. 3E. In such embodiments, the width 204 of the sheet 350 can be extended so as to allow for two cards 100, 102 to be inserted side by side. In other embodiments, the height dimension 202 may be extended to allow for multiple cards along the height dimension 202. Some embodiments can include extensions of both height and width dimensions 202, 204.

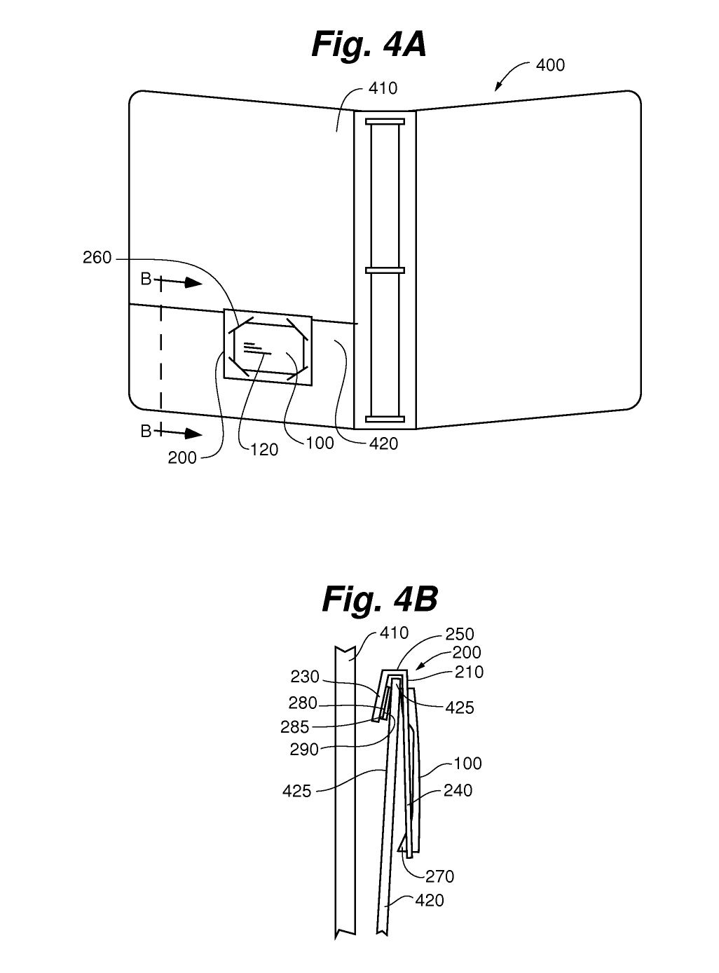

FIG. 4A shows a card holder 200 installed in a binder 400 according to some embodiments of the present invention. As shown, the card holder 200 can allow for display of information 120 on a business card 100 inserted into slits 260, without the need for built-in card display sleeves in the binder 400. Here, the card holder 200 is installed proximate the interior surface of front cover 410 of the binder 400 which includes pocket 420.

A cross-sectional view of the installation of FIG. 4A taken from the perspective of viewing lines B-B is shown in FIG. 4B. Here, corners 270 of a card 100 have been inserted into the second portion 240 of sheet 210 securing the card 100 in the card holder 200. The first portion 230 of the card holder 200 has been folded along demarcation 250 creating a flap 230 which has been inserted over the lip of the pocket 425 between the pocket 420 and the cover 410. In some installations, adhesive strip 280 may retain backing 290 to prevent adhesive surface 285 from adhering to the pocket 420 or cover 410. In such installations friction between pocket 420 and cover 410 can secure card holder 200 in place. In other installations, the backing 490 may be removed, allowing for adhesive surface 485 to bind to the pocket 420 or the cover 410.

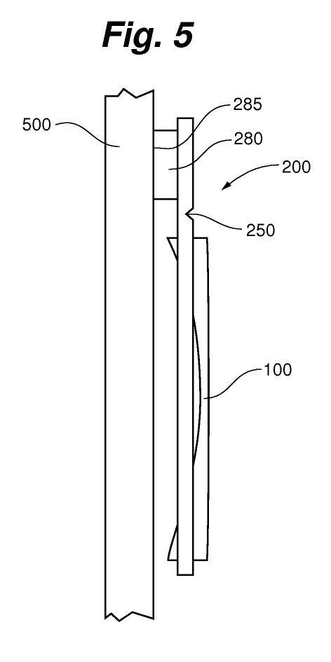

FIG. 5 shows another installation of a card holder 200 according to the embodiment of FIG. 2C. Here, the adhesive surface 285 of the adhesive strip 280 is placed in apposition to surface 500, affixing the card holder 200 to the surface 500. In this installation, to allow for proper viewing of the installed card 100, the card holder 200 was not folded along demarcation 250. Such an installation can provide for versatile placement and display of a card irrespective of the availability, or usability of a pocket.

It should be recognized installations of card holder embodiments such as those in FIGS. 4A-5 should not be limited to use with binders. These installations can be used to affix an embodiment of a card holder to other surfaces such as walls, bulletin boards, etc.

Using a card holder to display a card can involve two distinct steps. In one step, a card 100 can be installed into the card holder 200. This can be accomplished, for example as with the embodiment of FIG. 3A, by inserting the card 100 partially through slit 310 in the sheet 312. In alternative embodiments, the insertion of the card 100 of the card holder can include inserting corners of the card 270 into slits 320 (see, for example, FIG. 3B), or inserting edges of the card 338 into slits 330 (see, for example, FIG. 3C).

In another step, using embodiments of the card holder can involve coupling the a card holder to a surface. In some embodiments, for example the embodiment of FIG. 4B, this step includes folding the sheet 210 along a demarcation 250 and inserting the folded tab 230 over the lip of a pocket 425 of a binder 410. Coupling the binder to a surface can further include attaching an attachment mechanism to the binder or pocket. For example, if the embodiment includes an adhesive strip 480, a non-adhesive backing 490 can be removed to expose adhesive surface 485 which can, when placed in apposition with a surface 425, further bind the sheet 210 to the surface 425. This step of attaching an attachment mechanism may occur in conjunction with the above described folding and inserting steps.

Where attachment mechanisms other than adhesive strips are used, an installation similar to that of FIG. 5 is contemplated wherein the operation of the different attachment mechanism is substituted for the placement of the adhesive surface 485 in apposition to surface 500 described above.

Referring back to FIGS. 2A-2C, embodiments of a card holder 200 can be manufactured in a process including the steps of providing a sheet 210 of a card holder material, such as a material discussed above, and cutting the sheet 210 to the proper height and width dimensions 202, 204. Machine cutting or pressing slits 260 into each sheet 210. If applicable to the particular embodiment, a demarcation 250 can be printed, cut, or pre-folded on each sheet 210. If the particular embodiment is to include an attachment mechanism, such a mechanism can be installed on a surface of the sheet 210.

In the foregoing detailed description, the invention has been described with reference to specific embodiments. However, it may be appreciated that various modifications and changes can be made without departing from the scope of the invention as set forth in the appended claims.

What is claimed is:

1. A storage and display device for at least one card, comprising:
a sheet having a height and a width;
the sheet having a front surface and an opposite back surface;
the sheet having a first edge and a second edge wherein the first and second edges span the width of the sheet;
the sheet having a third edge and a fourth edge wherein the third and fourth edges span the height of the sheet;
the sheet having a demarcation along the width of the sheet for folding the first edge toward the second edge along the demarcation, the demarcation forming (1) a first portion bounded by the demarcation, the first edge, the third edge and the fourth edge, and (2) a second portion bounded by the demarcation, the second edge, the third edge and the fourth edge, the second portion having four corners: a first corner where the third edge meets the demarcation, a second corner where the fourth edge meets the demarcation, a third corner where the third edge meets the second edge, and a fourth corner where the fourth edge meets the second edge; and
the second portion having at least one slit oriented so as to allow for the insertion of a card within the at least one slit.

2. The device of claim 1 wherein the card is a business card.

3. The device of claim 1 wherein the first and second edges are generally parallel.

4. The device of claim 1 wherein the third and fourth edges are generally parallel.

5. The device of claim 1 wherein the demarcation is a groove.

6. The device of claim 1 wherein the demarcation is generally parallel to the first edge of the sheet.

7. The device of claim 1 wherein the at least one slit comprises at least two slits, oriented diagonally at opposite corners of the second portion.

8. The device of claim 1, wherein the at least one slit comprises four slits, oriented diagonally at each of the four corners of the second portion.

9. The device of claim 1, wherein the at least one slit comprises one slit oriented parallel to the second edge of the sheet the slit having a predetermined width approximately equal to the width of a business card.

10. The device of claim 1, wherein the width and the height of the card is such that at least two business cards may be positioned in at least two slits such that each business card is visible.

11. The device of claim 1, wherein the substantially rigid sheet comprises a paper board.

12. The device of claim 1, wherein the substantially rigid sheet comprises a plastic.

13. The device of claim 1, further comprising:
an attachment mechanism for attaching the sheet to a surface.

14. The device of claim 13, wherein the attachment mechanism includes at least one adhesive strip affixed to the back surface of the sheet.

15. A storage and display device for at least one card, comprising:
a sheet having a height and a width;
the sheet having a front surface and an opposite back surface;
the sheet having a first edge and a second edge wherein the first and second edges are generally parallel and span the width of the sheet;
the sheet having a third edge and a fourth edge wherein the third and fourth edges are generally parallel and span the height of the sheet;
the sheet having four corners: a first corner where the third edge meets the first edge, a second corner where the fourth edge meets the first edge, a third corner where the third edge meets the second edge, and a fourth corner where the fourth edge meets the second edge;
the sheet having at least one slit oriented so as to allow for the insertion of a card within the at least one slit;
an attachment mechanism for attaching the sheet to a surface.

16. The device of claim 15, wherein the attachment mechanism includes at least one adhesive strip affixed to the back surface of the sheet.

17. A method of storing and displaying a business card comprising the steps of:
providing a sheet having a height and a width; the sheet further having a front surface and an opposite back surface; the sheet further having a first edge and a second edge wherein the first and second edges span the width of the sheet; the sheet further having a third edge and a fourth edge wherein the third and fourth edges span the height of the sheet; the sheet further having a demarcation along the width of the sheet for folding the first edge toward the second edge along the demarcation, the demarcation forming (1) a first portion bounded by the demarcation, the first edge, the third edge and the fourth edge, and (2) a second portion bounded by the demarcation, the second edge, the third edge and the fourth edge, the second portion having four corners: a first corner where the third edge meets the demarcation, a second corner where the fourth edge meets the demarcation, a third corner where the third edge meets the second edge, and a fourth corner where the fourth edge meets the second edge; the second portion having at least one slit oriented so as to allow for the insertion of a card within the at least one slit;
inserting the business card into the at least one slit such that information on the business card is visible when viewing the sheet from its front surface; and
affixing the sheet to a binder.

18. The method of claim 17 wherein the binder comprises a three ring binder.

19. The method of claim 17 wherein the binder comprises a folder.

20. The method of claim 17 further comprising the steps of:
providing a sheet further having an adhesive strip with an adhesive protecting backing, fixedly attached to the back of the sheet;
removing the backing from the strip; and
placing the adhesive strip in apposition to a surface of a binder.

21. The method of claim 17 wherein the step of affixing the sheet to the binder further comprising the steps of:
providing a binder having a cover and a pocket thereon;
folding the sheet along the demarcation; and
inserting the first portion into the pocket.
